(19) United States
(12) Patent Application Publication
(10) Pub. No.: US 2026/0286774 A1
(43) Pub. Date: Sep. 24, 2026

(54) SELF-ADJUSTING PRE-TENSIONING DEVICE FOR ROLLER SHADE

(71) Applicant: Zhejiang Risingsun Sunshading Technology Co., Ltd., Shaoxing (CN)

(72) Inventors: Yali CHEN, Shaoxing (CN); Haiyan WANG, Shaoxing (CN)

(21) Appl. No.: 19/670,099

(22) Filed: May 7, 2026

(30) Foreign Application Priority Data
Mar. 11, 2026 (CN) 202620296055.X

(51) Int. Cl. E06B 9/90; E06B 9/42; E06B 9/60

(52) U.S. Cl. CPC E06B 9/90; E06B 9/42; E06B 9/60

(57) ABSTRACT

A self-adjusting pre-tensioning device for a roller shade includes a brake assembly and a spring, where the roller shade includes a core rod, a fixed brake member, a support roller. The brake assembly is arranged at a first end of the core rod. The fixed brake member and the support roller are arranged at a second end of the core rod. The brake assembly includes a rotary outer sleeve, a sleeve seat, a clutch mechanism and a mounting frame. The rotary outer sleeve is circumferentially provided with a plurality of ratchet teeth. The clutch mechanism includes a locking pawl, which are configured to be radially movable, and to engage with the plurality of ratchet teeth to form a one-way locking mechanism. The mounting frame is provided with an unlocking tongue configured to be slidably inserted into the sleeve seat.

### CROSS-REFERENCE TO RELATED APPLICATIONS

This application claims the benefit of priority from Chinese Patent Application No. 202620296055.X, filed on Mar. 11, 2026. The content of the aforementioned application, including any intervening amendments thereto, is incorporated herein by reference in its entirety.

### TECHNICAL FIELD

This application relates to roller shades, and more particularly to a self-adjusting pre-tensioning device for a roller shade.

### BACKGROUND

The existing cordless spring-driven roller shades typically depend on the elastic potential energy generated by winding the spring to balance the gravitational potential energy of the lowered shade. The spring functions as a core component in the roller shade system, and its pre-tensioning performance will directly affect the lifting-lowering smoothness and operational stability of the roller shades.

There are two main pre-tensioning strategies for the spring-driven roller shades. The first is the “pre-tensioning during installation” mode, in which users manually adjust the pre-tensioning force with external tools such as wrenches and screwdrivers during the installation stage. However, this method struggles with cumbersome operation and high requirements for the users' manual skill. The second is the “factory pre-tensioning” mode, in which the pre-tensioning force is preset by a brake mechanism. Although the adjustment step during installation is omitted, the structural design is complex, and involves numerous components. This not only increases the manufacturing cost but also reduces the reliability of the overall structure.

Consequently, there is an urgent need to provide a structurally-simple and readily-operable self-adjusting pre-tensioning device for a roller shade.

### SUMMARY

An object of the present disclosure is to provide a self-adjusting tensioning device for a roller shade, which features simple structure and low manufacturing cost, and enables users to easily adjust the spring pre-tightening force by themselves without the need for additional tools.

The present disclosure adopts the following technical solutions.

A self-adjusting pre-tensioning device for a roller shade, the roller shade comprising a fixed brake member, a support roller and a core rod, and the device comprising:

a brake assembly; and

a spring;

wherein the brake assembly is arranged at a first end of the core rod; and the fixed brake member and the support roller are arranged at a second end of the core rod;

the brake assembly comprises a rotary outer sleeve, a sleeve seat, a clutch mechanism and a mounting frame;

a first end of the spring is hooked onto an outer end of the rotary outer sleeve, and a second end of the spring is hooked onto an outer end of the fixed brake member;

an inner sidewall of the rotary outer sleeve is evenly provided with a plurality of ratchet teeth along a circumferential direction of the rotary outer sleeve;

the sleeve seat is axially limited and embedded within the rotary outer sleeve, and is non-rotatably and fixedly engaged with the core rod;

the clutch mechanism is arranged inside the sleeve seat; the clutch mechanism is provided with a locking pawl capable of moving along a radial direction of the sleeve seat; and the locking pawl is configured to cooperate with the plurality of ratchet teeth to form a one-way locking mechanism;

the mounting frame is provided with an unlocking tongue; and the unlocking tongue is slidably inserted into the sleeve seat, and is configured to abut against the clutch mechanism to drive the locking pawl to radially extend and retract;

in response to a pre-tensioned state, the mounting frame is disengaged from the clutch mechanism, the locking pawl is configured to extend out of the sleeve seat and engage with the plurality of ratchet teeth; and

in response to a released state, the mounting frame is inserted into the sleeve seat, the locking pawl is configured to retract into the sleeve seat and disengage from the plurality of ratchet teeth.

In some embodiments, the clutch mechanism comprises a connection seat, a clutch component and a telescopic braking tongue arranged sequentially from outside to inside;

the connection seat is axially limited and non-rotatably embedded within the sleeve seat;

the clutch component is elastically and slidably connected to the connection seat along an axial direction;

the telescopic braking tongue is slidably arranged inside the sleeve seat along a radial direction;

the locking pawl is arranged at an outer end of the telescopic braking tongue;

the clutch component is provided with a first inclined surface, and the telescopic braking tongue is provided with a second inclined surface; the first inclined surface is configured to radially cooperate with the second inclined surface; in response to the pre-tensioned state, the first inclined surface is configured to be separated from the second inclined surface; in response to the released state, the first inclined surface is configured to abut against the second inclined surface; and

the sleeve seat is provided with a first groove, and the first groove is configured to radially penetrate through the sleeve seat; and the locking pawl is slidably received within the first groove.

In some embodiments, the connection seat comprises a base and two fixed cylinders; the two fixed cylinders are fixedly arranged on an upper side and a lower side of the base, respectively; the two fixed cylinders are each configured to extend in a direction away from the mounting frame; the two fixed cylinders are each internally and axially provided with a sliding groove; and the clutch component is arranged on a side of the connection seat away from the mounting frame; and

the clutch component comprises an elastic cross part and two first compression springs; the elastic cross part comprises two sliding cylinders and two elastic blocks; the two sliding cylinders and the two elastic blocks are integrally formed; the two sliding cylinders are respectively arranged at first opposite sides, and the two elastic blocks are respectively arranged at a second opposite sides, so as to form a cross structure; the two sliding cylinders are each configured to be slidably inserted into the sliding groove, so as to allow the elastic cross part to axially move; a bottom surface of an inner cavity defined within the sleeve seat is fixedly provided with a spring cylinder; a first end of each of the two first compression springs is configured to abut against an end surface of each of the two sliding cylinders; a second end of each of the two first compression springs is fitted onto an outer side of the spring cylinder; and the first end of each of the two first compression springs is at least partially located in the sliding groove.

In some embodiments, two ends of the two elastic blocks are configured to extend toward the core rod, so as to form a second groove configured for accommodating the telescopic braking tongue; an inner sidewall of the sleeve seat is axially provided with a third groove; and the two elastic blocks are slidably received within the third groove.

In some embodiments, opposite end surfaces of the two elastic blocks are each provided with a third inclined surface; the second inclined surface is provided at a side of the telescopic braking tongue to matchingly abut against the third inclined surface; a side of the telescopic braking tongue away from the second inclined surface is transversely provided with a second groove; the second groove is internally provided with a second compression spring; a first end of the second compression spring is configured to abut against a bottom surface of the second groove; and a second end of the second compression spring is configured to abut against the inner sidewall of the sleeve seat.

In some embodiments, the base of the connection seat is provided with an unlocking groove penetrating through the base; and the unlocking tongue is slidably connected to the unlocking groove, so as to drive the elastic cross part to axially move in the direction away from the mounting frame.

In some embodiments, the sleeve seat comprises a positioning segment and a pre-tensioning segment; the positioning segment is an outer portion of the sleeve seat away from the core rod; the pre-tensioning segment is an inner portion of the sleeve seat; and

the pre-tensioning segment is internally provided with a square groove fitting the core rod; the core rod is configured to be inserted into the square groove; in response to a case that the core rod is inserted into the square groove, an end surface of the core rod is configured to abut against a bottom surface of the square groove; the pre-tensioning segment is provided with a pin hole running through the pre-tensioning segment; the core rod is provided with a through hole; in response to a case that the core rod reaches the pre-tensioning segment, the through hole is coaxially aligned with the pin hole; and the pin hole is internally provided with an elastic pin configured for mounting the core rod.

In some embodiments, a wall of the pre-tensioning segment adjacent to the core rod is symmetrically provided with two slotted elastic tube lobs; the wall of the pre-tensioning segment is made of an elastic or tough material; the two slotted elastic tube lobs are configured to generate a radial deformation; an outer wall of each of the two slotted elastic tube lobs is provided with a limit protrusion configured to protrude outward; the limit protrusion is configured to retract into the sleeve seat to mount the sleeve seat onto the rotary outer sleeve; and

in response to a case that the rotary outer sleeve is mounted onto an outer side of the sleeve seat, a step limit structure is formed between an inner wall of the rotary outer sleeve and an outer wall of the sleeve seat; and an outer peripheral end surface of the rotary outer sleeve is configured to abut against an end surface of the limit protrusion adjacent to the positioning segment, so that the rotary outer sleeve is axially limited and mounted onto the outer side of the sleeve seat.

In some embodiments, the fixed brake member is non-rotatably sleeved on an outer periphery of the core rod; and the support roller is detachably sleeved on an outer periphery of a side of the fixed brake member away from the rotary outer sleeve.

Compared to the prior art, the present disclosure has the following beneficial effects.

By setting the rotary outer sleeve, the sleeve seat, the clutch mechanism, the mounting frame and the spring, the locking pawl protrudes outward to matchingly connect to the rotary outer sleeve when the mounting frame is disengaged from the sleeve seat. This establishes a one-way rotational engagement between the rotary outer sleeve and the sleeve seat that prevents reverse rotation of the rotary outer sleeve, thereby winding the spring to generate a pre-tensioning force. When the unlocking tongue is inserted into the connection seat, the elastic cross part is pushed to horizontally move in the direction away from the mounting frame. Furthermore, the second inclined surface is configured to matchingly abut against the third inclined surface, driving the telescopic braking tongue to move inward until the locking pawl is disengaged from the plurality of ratchet teeth. Under the action of the pre-tensioning force, the spring drives the rotary outer sleeve to rotate. The device features a simple structure and low manufacturing cost. Moreover, without requiring additional tools, it enables users to conveniently adjust the spring pre-tensioning force manually.

### BRIEF DESCRIPTION OF THE DRAWINGS

FIG. 1 schematically shows an overall structure of a self-adjusting pre-tensioning device for a roller shade according to an embodiment of the present disclosure;

FIG. 2 is an exploded view of the device according to an embodiment of the present disclosure;

FIG. 3 is a partially sectional view of a rotary outer sleeve according to an embodiment of the present disclosure;

FIG. 4 schematically shows an overall structure of a sleeve seat according to an embodiment of the present disclosure;

FIG. 5 schematically shows an internal structure of the sleeve seat according to an embodiment of the present disclosure;

FIG. 6 is an exploded view of a connection seat, a clutch component and a telescopic braking tongue according to an embodiment of the present disclosure;

FIG. 7 schematically shows a brake assembly according to an embodiment of the present disclosure (in a released state);

FIG. 8 is a sectional view of the brake assembly according to an embodiment of the present disclosure (in the released state);

FIG. 9 is a sectional view of the brake assembly according to an embodiment of the present disclosure (in a pre-tensioned state);

FIG. 10 schematically shows an operational principle of a clutch component according to an embodiment of the present disclosure;

FIG. 11 is an exploded view of an elastic pin according to an embodiment of the present disclosure;

FIG. 12 schematically shows a fixed brake member and a support roller according to an embodiment of the present disclosure;

FIG. 13 schematically shows an operational principle of the brake assembly according to an embodiment of the present disclosure;

FIG. 14 schematically shows an assembly relationship between the rotary outer sleeve and the sleeve seat according to an embodiment of the present disclosure;

FIG. 15 schematically shows an assembly relationship between the rotary outer sleeve and the spring according to an embodiment of the present disclosure;

FIG. 16 is a partially sectional view of the self-adjusting tensioning device according to an embodiment of the present disclosure (in the pre-tensioned state); and

FIG. 17 is a partially sectional view of the self-adjusting tensioning device according to an embodiment of the present disclosure (in the released state).

In the figures: 1-rotary outer sleeve; 11-positioning cylinder; 12-pre-tensioning block; 13-ratchet tooth; 14-pre-tensioning cylinder; 2-sleeve seat; 21-first groove; 22-mounting groove; 23-spring cylinder; 24-second groove; 25-square groove; 26-limit protrusion; 27-pin hole; 28-support plate; 3-connection seat; 31-unlocking groove; 32-fixed cylinder; 33-sliding groove; 34-mounting block; 4-clucth component; 41-elastic cross part; 411-sliding cylinder; 412-elastic block; 42-first compression spring; 5-telescopic braking tongue; 51-spring groove; 52-second inclined surface; 53-locking pawl; 54-second compression spring; 6-mounting frame; 61-unlocking tongue; 7-core rod; 71-elastic pin; 8-spring; 9-fixed brake member; and 10-support roller.

### DETAILED DESCRIPTION OF EMBODIMENTS

### Embodiment 1

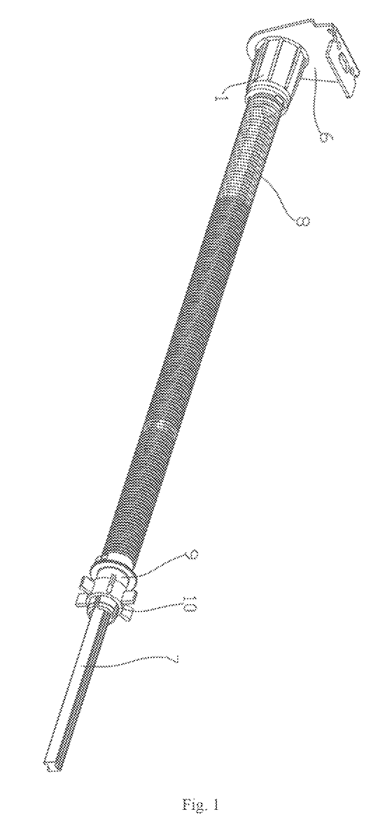

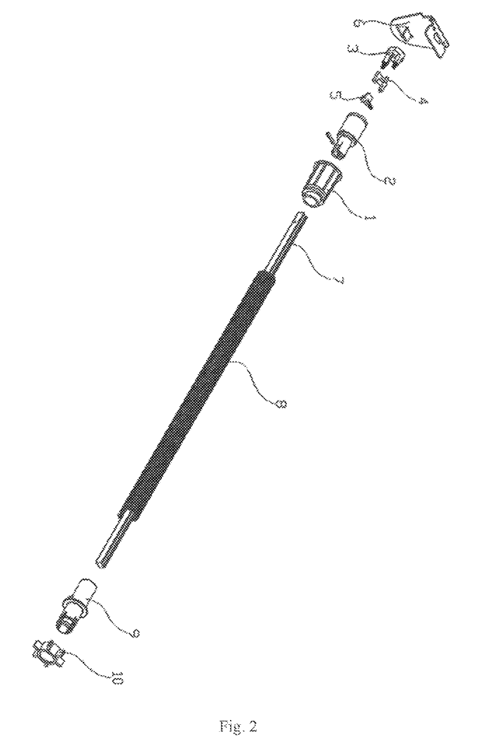

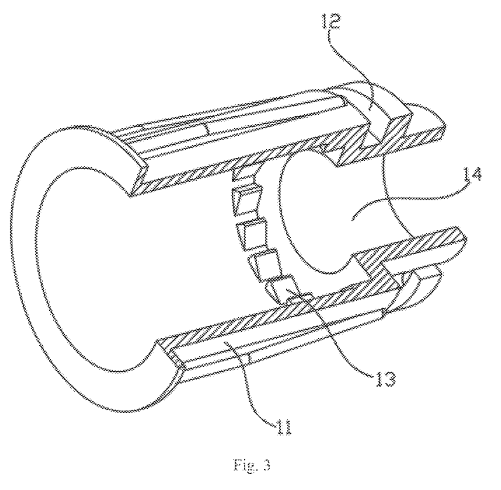

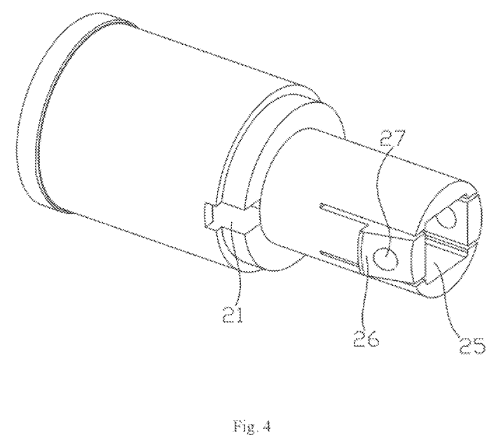

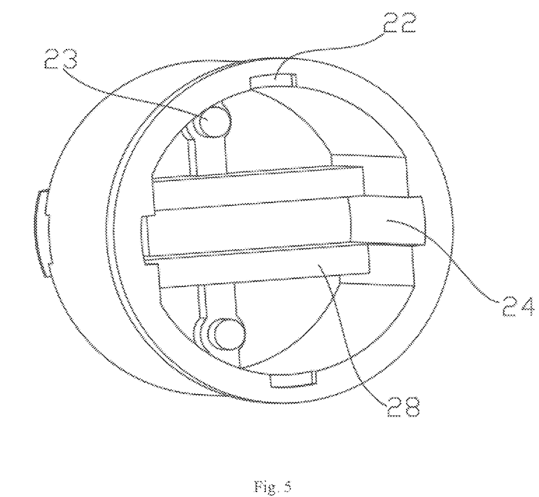

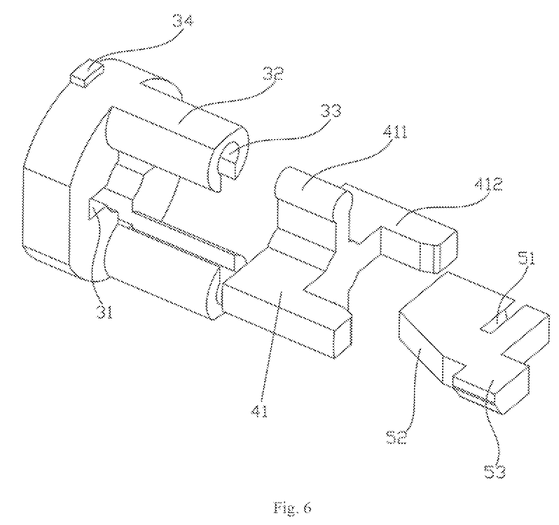

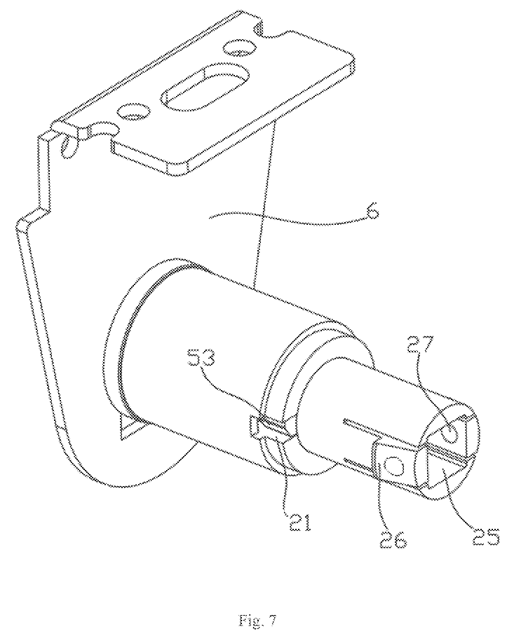

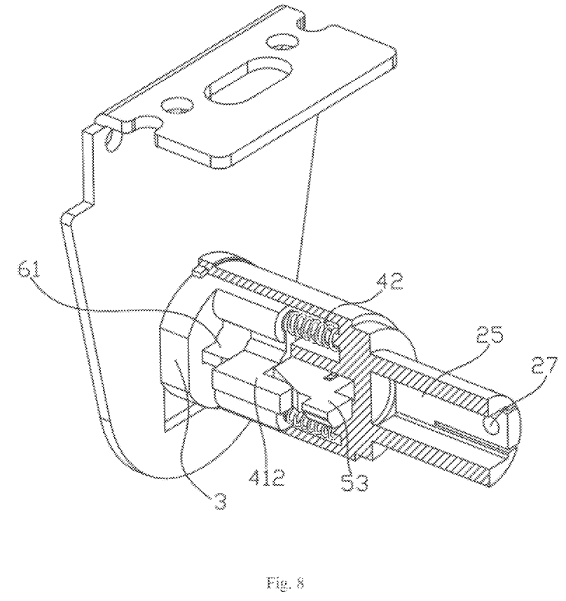

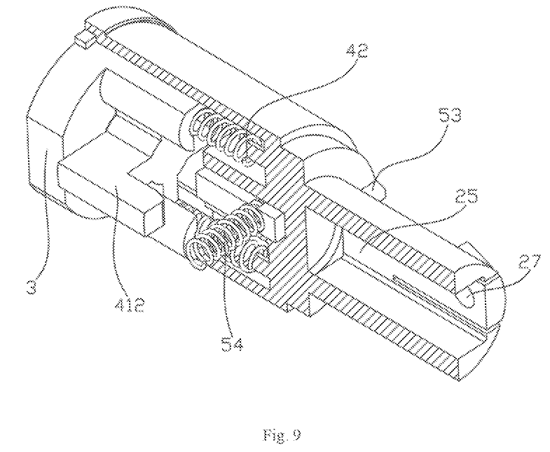

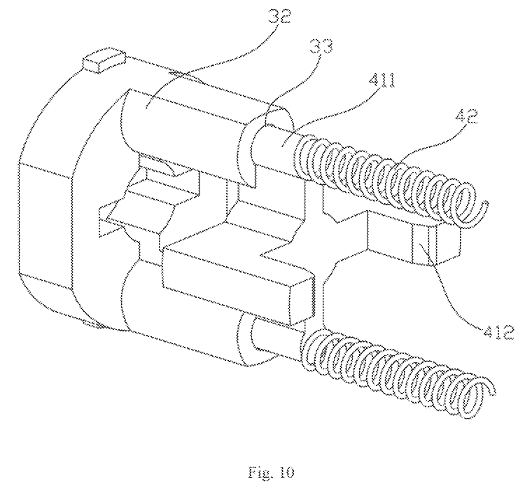

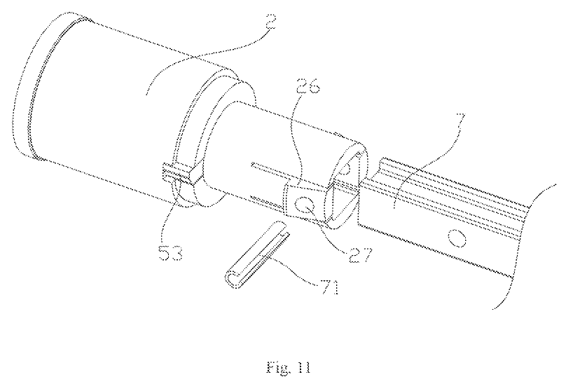

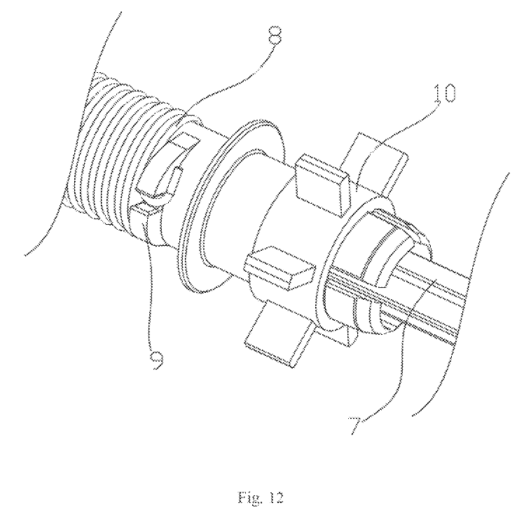

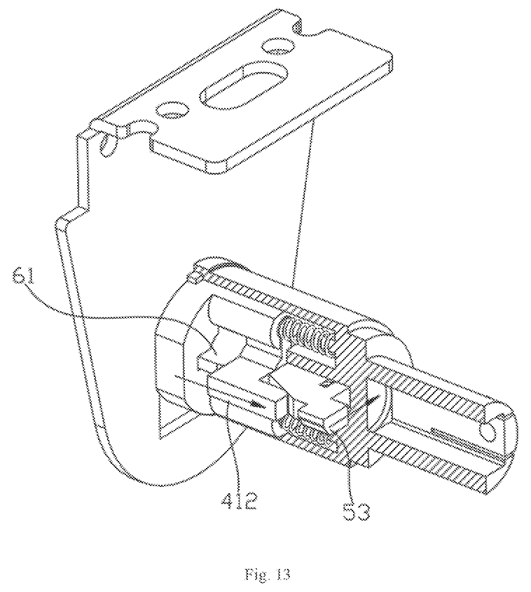

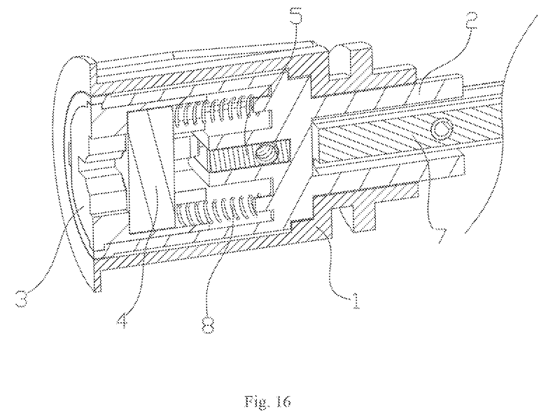

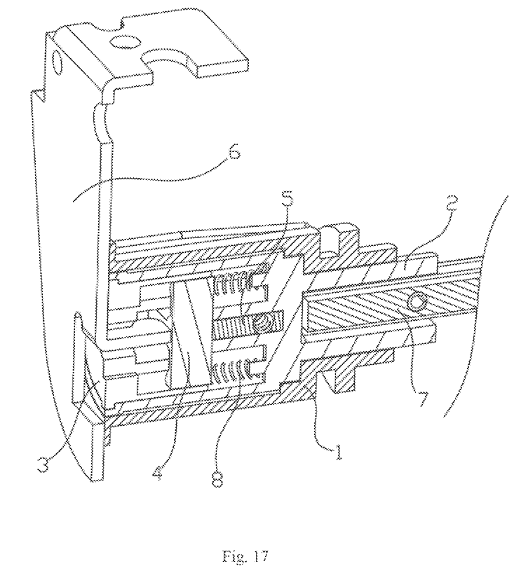

Referring to FIGS. 1-17, the present disclosure provides a self-adjusting tensioning device for a roller shade, including a brake assembly and a spring 8. The roller shade includes a core rod 7, a fixed brake member 9 and a support roller 10.

The brake assembly is arranged at a first end of the core rod 7. The fixed brake member 9 and the support roller 10 are arranged at a second end of the core rod 7. The brake assembly is detachably connected to the core rod 7 through an elastic pin 71. The fixed brake member 9 is fixedly sleeved on an outer side of the core rod 7. The support roller 10 is arranged on a side of the fixed brake member 9 away from the brake assembly. The support roller 10 is detachably connected to the fixed brake member 9. The spring 8 is sleeved on the outer side of the core rod 7. A first end of the spring 8 is connected to the brake assembly, and a second end of the spring 8 is connected to the fixed brake member 9.

A roller tube (not shown in FIGS. 1-17) is arranged between the brake assembly and the support roller 10. The roller tube is sleeved on an outer side of the spring 8. A first end of the roller tube is connected to a rotary outer sleeve 1 of the brake assembly. A second end of the roller tube is connected to the support roller 10. The roller shade is arranged on the roller tube. The roller tube and the roller shade are conventional components in the prior art. For the sake of brevity, there are no elaborations for their connection relationships and operational principles. When the core rod 7 rotates, the roller tube rotates synchronously.

The brake assembly includes the rotary outer sleeve 1, a sleeve seat 2, a connection seat 3, a clutch component 4, a telescopic braking tongue 5 and a mounting frame 6. The connection seat 3, the clutch component 4 and the telescopic braking tongue 5 are arranged sequentially from outside to inside, and are arranged inside the sleeve seat 2. The rotary outer sleeve 1 is sleeved on an outer side of the sleeve seat 2, and is configured for connecting to the spring 8. The rotary outer sleeve 1 is detachably connected to the sleeve seat 2. The mounting frame 6 is arranged on a side of the rotary outer sleeve 1 away from the core rod 7. An end of the mounting frame 6 is inserted into the connection seat 3 to drive the clutch component 4 to move axially.

The rotary outer sleeve 1 includes a positioning cylinder 11 and a pre-tensioning cylinder 14, where the positioning cylinder 11 is an outer portion of the rotary outer sleeve 1, and the pre-tensioning cylinder 14 is an inner portion of the rotary outer sleeve 1. The positioning cylinder 11 is internally provided with a first hole, and the pre-tensioning cylinder 14 is internally provided with a second hole. The first hole is configured to communicate with the second hole to form a stepped cavity for accommodating the sleeve seat 2. An inner wall of a side of the positioning cylinder 11 adjacent to the pre-tensioning cylinder 14 is evenly provided with a plurality of ratchet teeth 13. An inner diameter of the positioning cylinder 11 is larger than that of the pre-tensioning cylinder 14 to form a stepped surface.

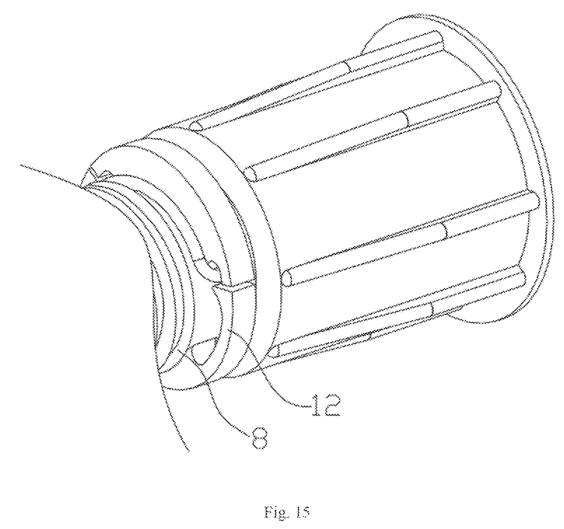

Referring to FIG. 15, an outer periphery of the pre-tensioning cylinder 14 is fixedly provided with a pre-tensioning block 12. The pre-tensioning block 12 is provided with a first through groove configured for hooking. A first end of the spring 8 is hooked onto the first through groove to connect the spring 8 to the rotary outer sleeve 1. The fixed brake member 9 is provided with a second through groove configured for hooking. A second end of the spring 8 is hooked onto the second through groove. The sleeve seat 2 includes a positioning segment and a pre-tensioning segment, where the positioning segment is an outer portion of the sleeve seat 2 away from the core rod 7, and the pre-tensioning segment is an inner portion of the sleeve seat 2. A wall of the pre-tensioning segment adjacent to the core rod 7 is symmetrically provided with two slotted elastic tube lobs. The wall of the pre-tensioning segment is made of an elastic or tough material. The two slotted elastic tube lobs are configured to generate a radial deformation. An outer wall of each of the two slotted elastic tube lobs is provided with a limit protrusion 26 configured to protrude outward. The limit protrusion 26 is configured to properly retract into the sleeve seat 2 to mount the sleeve seat 2 onto the rotary outer sleeve 1. When the rotary outer sleeve 1 is mounted onto the outer side of the sleeve seat 2, a step limit structure is formed between an inner wall of the rotary outer sleeve 1 and an outer wall of the sleeve seat 2.

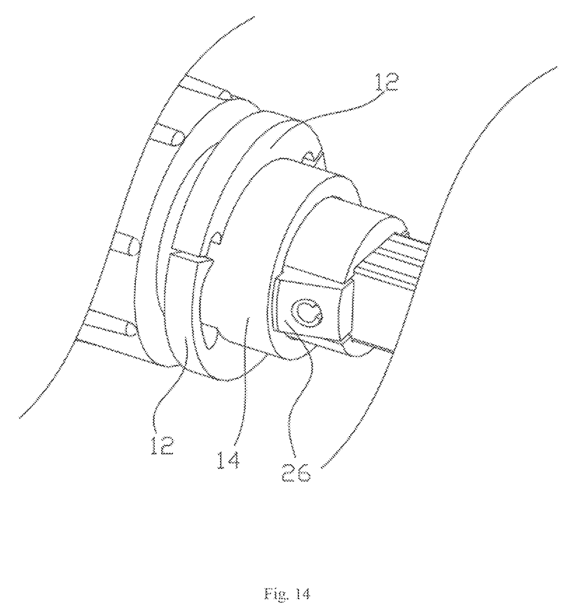

Referring to FIG. 14, an outer peripheral end surface of a pre-tensioning cylinder 14 is configured to abut against an end surface of the limit protrusion 26 adjacent to the positioning segment, so that the rotary outer sleeve 1 is axially limited and mounted onto the outer side of the sleeve seat 2. The pre-tensioning segment is internally provided with a square groove 25 fitting the core rod 7 to allow the square groove 25 and the core rod 7 to rotate synchronously. The core rod 7 is configured to be inserted into the square groove 25. When the core rod 7 is inserted into the square groove 25, an end surface of the core rod 7 is configured to abut against a bottom surface of the square groove 25. The limit protrusion 26 is provided with a pin hole 27 running through the pre-tensioning segment. The core rod 7 is provided with a through hole corresponding to the pin hole 27. When the core rod 7 reaches the pre-tensioning segment, the through hole is coaxially aligned with the pin hole 27. The pin hole 27 is internally provided with an elastic pin 71 configured for detachably connecting the core rod 7 to the sleeve seat 2.

The connection seat 3 is arranged in the positioning segment of the sleeve seat 2. The connection seat 3 includes a base and two fixed cylinders 32. An outer side of the base is symmetrically and fixedly provided with two mounting blocks 34 configured to protrude outward. An end surface of the sleeve seat 2 is correspondingly provided with a mounting groove 22. When the connection seat 3 is arranged in the sleeve seat 2, the two mounting blocks 34 are embedded within the mounting groove 22 to enable axial positioning of the connection seat 3. A left side and a right side of the base are symmetrically provided with a vertical section. An inner sidewall of the positioning segment is correspondingly provided with the same vertical section to allow the base to matchingly abut against the positioning segment. A center of the base is provided with an unlocking groove 31. The number of the fixed cylinders 32 is two. The two fixed cylinders 32 are symmetrically and fixedly arranged at an upper side and a lower side of the unlocking groove 31. The two fixed cylinders 32 are configured to extend in a direction away from the mounting frame 6. The two fixed cylinders 32 are each internally provided with a sliding groove 33 along a length direction thereof, so as to mount the clutch component 4.

The clutch component 4 is arranged at a side of the connection seat 3 away from the mounting frame 6. The clutch component 4 includes an elastic cross part 41 and two first compression springs 42. The elastic cross part 41 includes two sliding cylinders 411 and two elastic blocks 412. The two sliding cylinders 411 and the two elastic blocks 412 are integrally formed. The two sliding cylinders 411 are respectively arranged at an upper side and a lower side of the elastic cross part 41, and the two elastic blocks 412 are respectively arranged at a left side and a right side of the elastic cross part 41, so as to form a cross structure. The two sliding cylinders 411 are each configured to be slidably inserted into the sliding groove 33, so as to allow the elastic cross part 41 to axially move.

Two ends of the two elastic blocks 412 are configured to extend toward the core rod 7, so as to form an accommodating groove configured for accommodating the telescopic braking tongue 5. An inner sidewall of the positioning segment is axially provided with a second groove 24. The two elastic blocks 412 are slidably received within the second groove 24. Opposite end surfaces of the two elastic blocks 412 are provided with a first inclined surface. The two first compression springs 42 are each arranged on a side of the sliding cylinder 411 away from the mounting frame 6. A first end of each of the two first compression springs 42 is at least partially located in the sliding groove 33. A bottom surface of an inner cavity defined within the positioning segment is fixedly provided with a spring cylinder 23. The first end of each of the two first compression springs 42 is configured to abut against an end surface of each of the two sliding cylinders 411. A second end of each of the two first compression springs 42 is fitted onto an outer side of the spring cylinder 23.

The bottom surface of the inner cavity of the positioning segment is fixedly provided with two supporting plates 28. The two supporting plates 28 are arranged spaced apart at an upper side and a lower side of each of the two elastic blocks 412. A gap is provided between the two supporting plates 28. The telescopic braking tongue 5 is arranged in the gap between the two supporting plates 28. A side of the telescopic braking tongue 5 is provided with a second inclined surface 52 to matchingly abut against the first inclined surface. A side of the telescopic braking tongue 5 away from the second inclined surface 52 is transversely provided with a spring groove 51. A second compression spring 54 is arranged inside the spring groove 51. A first end of the second compression spring 54 is configured to abut against a bottom surface of the spring groove 51. A second end of the second compression spring 54 is configured to abut against a sidewall of the sleeve seat 2. The telescopic braking tongue 5 is provided with a locking pawl 53 located on the same side of the second inclined surface 52. An outer periphery of a support segment of the sleeve seat 2 is provided with a first groove 21. The first groove 21 is located in the gap between the two supporting plates 28. The locking pawl 53 is slidably connected to the first groove 21.

In a pre-tensioned state, the locking pawl 53 protrudes outward through the first groove 21 to engage with the plurality of ratchet teeth 13. When the rotary outer sleeve 1 rotates in a release direction, the locking pawl 53 abuts against the plurality of ratchet teeth 13 to compress the second compression spring 54. The first compression spring 42 remains compressed to abut against the elastic cross part 41 and allow the elastic cross part 41 to abut against the connection seat 3, so as to provide enough space for the radial movement of the locking pawl 53. As the plurality of ratchet teeth 13 pass over the locking pawl 53 during rotation, the locking pawl 53 moves inward until the plurality of ratchet teeth 13 align with a gap between two adjacent ratchet teeth 13 at a desired position. The second compression spring 54 is reset to drive the locking pawl 53 to move outward until the locking pawl 53 is engaged with the ratchet tooth 13. The rotary outer sleeve 1 is rotatably engaged with the sleeve seat 2 in a single direction, so that the rotary outer sleeve 1 is limited and fails to reversely rotate, thereby driving the spring 8 to perform torsion to generate a pre-tensioning force.

The mounting frame 6 is fixedly provided with an unlocking tongue 61 configured to extend outward. During operation, the unlocking tongue 61 is inserted into the unlocking groove 31, and is slidably connected to the unlocking groove 31, so as to push the elastic cross part 41 to axially move in the direction away from the mounting frame 6.

The operational principles of this application are illustrated as follows.

In the pre-tensioned state, the mounting frame 6 is not inserted into the connection seat 3. The locking pawl 53 is configured to protrude outward, and is matchingly connected to the rotary outer sleeve 1. When rotating, the locking pawl 53 is configured to abut against the plurality of ratchet teeth 13, so as to compress the second compression spring 54. The first compression spring 42 remains compressed to abut against the elastic cross part 41 and allow the elastic cross part 41 to abut against the connection seat 3, so as to provide enough space for the radial movement of the locking pawl 53. As the plurality of ratchet teeth 13 pass over the locking pawl 53 during rotation, the locking pawl 53 moves inward until the plurality of ratchet teeth 13 align with a gap between two adjacent ratchet teeth 13 at a desired position. The second compression spring 54 is reset to drive the locking pawl 53 to move outward until the locking pawl 53 is engaged with the ratchet tooth 13. The rotary outer sleeve 1 is rotatably engaged with the sleeve seat 2 in a single direction, so that the rotary outer sleeve 1 is limited and fails to reversely rotate, thereby driving the spring 8 to perform torsion to generate the pre-tensioning force.

In the released state, the unlocking tongue 61 of the mounting frame 6 is inserted into the connection seat 3, so as to push the elastic cross part 41 to axially move in the direction away from the mounting frame 6. The second inclined surface 52 is configured to matchingly abut against the first inclined surface. The telescopic braking tongue 5 is configured to move inward. The locking pawl 53 is disengaged from the plurality of ratchet teeth 13. The spring 8 is configured to drive the rotary outer sleeve 1 to rotate under the action of the pre-tensioning force.

What is claimed is:

1. A self-adjusting pre-tensioning device for a roller shade, the roller shade comprising a fixed brake member, a support roller and a core rod, and the device comprising:
a brake assembly; and
a spring;
wherein the brake assembly is arranged at a first end of the core rod; and the fixed brake member and the support roller are arranged at a second end of the core rod;
the brake assembly comprises a rotary outer sleeve, a sleeve seat, a clutch mechanism and a mounting frame;
a first end of the spring is hooked onto an outer end of the rotary outer sleeve, and a second end of the spring is hooked onto an outer end of the fixed brake member;
an inner sidewall of the rotary outer sleeve is evenly provided with a plurality of ratchet teeth along a circumferential direction of the rotary outer sleeve;
the sleeve seat is axially limited and embedded within the rotary outer sleeve, and is non-rotatably and fixedly engaged with the core rod;
the clutch mechanism is arranged inside the sleeve seat; the clutch mechanism is provided with a locking pawl capable of moving along a radial direction of the sleeve seat; and the locking pawl is configured to cooperate with the plurality of ratchet teeth to form a one-way locking mechanism;
the mounting frame is provided with an unlocking tongue; and the unlocking tongue is slidably inserted into the sleeve seat, and is configured to abut against the clutch mechanism to drive the locking pawl to radially extend and retract;
in response to a pre-tensioned state, the mounting frame is disengaged from the clutch mechanism, the locking pawl is configured to extend out of the sleeve seat and engage with the plurality of ratchet teeth; and
in response to a released state, the mounting frame is inserted into the sleeve seat, the locking pawl is configured to retract into the sleeve seat and disengage from the plurality of ratchet teeth.

2. The device of claim 1, wherein the clutch mechanism comprises a connection seat, a clutch component and a telescopic braking tongue arranged sequentially from outside to inside;
the connection seat is axially limited and non-rotatably embedded within the sleeve seat;
the clutch component is elastically and slidably connected to the connection seat along an axial direction;
the telescopic braking tongue is slidably arranged inside the sleeve seat along a radial direction;
the locking pawl is arranged at an outer end of the telescopic braking tongue;
the clutch component is provided with a first inclined surface, and the telescopic braking tongue is provided with a second inclined surface; the first inclined surface is configured to radially cooperate with the second inclined surface; in response to the pre-tensioned state, the first inclined surface is configured to be separated from the second inclined surface; in response to the released state, the first inclined surface is configured to abut against the second inclined surface; and
the sleeve seat is provided with a first groove, and the first groove is configured to radially penetrate through the sleeve seat; and the locking pawl is slidably received within the first groove.

3. The device of claim 2, wherein the connection seat comprises a base and two fixed cylinders; the two fixed cylinders are fixedly arranged on an upper side and a lower side of the base, respectively; the two fixed cylinders are each configured to extend in a direction away from the mounting frame; the two fixed cylinders are each internally and axially provided with a sliding groove; and the clutch component is arranged on a side of the connection seat away from the mounting frame; and
the clutch component comprises an elastic cross part and two first compression springs; the elastic cross part comprises two sliding cylinders and two elastic blocks; the two sliding cylinders and the two elastic blocks are integrally formed; the two sliding cylinders are respectively arranged at first opposite sides, and the two elastic blocks are respectively arranged at second opposite sides, so as to form a cross structure; the two sliding cylinders are each configured to be slidably inserted into the sliding groove, so as to allow the elastic cross part to axially move; a bottom surface of an inner cavity defined within the sleeve seat is fixedly provided with a spring cylinder; a first end of each of the two first compression springs is configured to abut against an end surface of each of the two sliding cylinders; a second end of each of the two first compression springs is fitted onto an outer side of the spring cylinder; and the first end of each of the two first compression springs is at least partially located in the sliding groove.

4. The device of claim 3, wherein two ends of the two elastic blocks are configured to extend toward the core rod, so as to form a second groove configured for accommodating the telescopic braking tongue; an inner sidewall of the sleeve seat is axially provided with a third groove; and the two elastic blocks are slidably received within the third groove.

5. The device of claim 3, wherein opposite end surfaces of the two elastic blocks are each provided with a third inclined surface; the second inclined surface is provided at a side of the telescopic braking tongue, and is configured to matchingly abut against the third inclined surface; a side of the telescopic braking tongue away from the second inclined surface is transversely provided with a second groove; the second groove is internally provided with a second compression spring; a first end of the second compression spring is configured to abut against a bottom surface of the second groove; and a second end of the second compression spring is configured to abut against the inner sidewall of the sleeve seat.

6. The device of claim 3, wherein the base of the connection seat is provided with an unlocking groove penetrating through the base; and the unlocking tongue is slidably connected to the unlocking groove, so as to drive the elastic cross part to axially move in the direction away from the mounting frame.

7. The device of claim 1, wherein the sleeve seat comprises a positioning segment and a pre-tensioning segment; the positioning segment is an outer portion of the sleeve seat away from the core rod; the pre-tensioning segment is an inner portion of the sleeve seat; and
the pre-tensioning segment is internally provided with a square groove fitting the core rod; the core rod is configured to be inserted into the square groove; in response to a case that the core rod is inserted into the square groove, an end surface of the core rod is configured to abut against a bottom surface of the square groove; the pre-tensioning segment is provided with a pin hole running through the pre-tensioning segment; the core rod is provided with a through hole corresponding to the pin hole; in response to a case that the core rod reaches the pre-tensioning segment, the through hole is coaxially aligned with the pin hole; and the pin hole is internally provided with an elastic pin configured for mounting the core rod.

8. The device of claim 7, wherein a wall of the pre-tensioning segment adjacent to the core rod is symmetrically provided with two slotted elastic tube lobs; the wall of the pre-tensioning segment is made of an elastic or tough material; the two slotted elastic tube lobs are configured to generate a radial deformation; an outer wall of each of the two slotted elastic tube lobs is provided with a limit protrusion configured to protrude outward; the limit protrusion is configured to retract into the sleeve seat to mount the sleeve seat onto the rotary outer sleeve; and
in response to a case that the rotary outer sleeve is mounted onto an outer side of the sleeve seat, a step limit structure is formed between an inner wall of the rotary outer sleeve and an outer wall of the sleeve seat; and an outer peripheral end surface of the rotary outer sleeve is configured to abut against an end surface of the limit protrusion adjacent to the positioning segment, so that the rotary outer sleeve is axially limited and mounted onto the outer side of the sleeve seat.

9. The device of claim 7, wherein the fixed brake member is non-rotatably sleeved on an outer periphery of the core rod; and the support roller is detachably sleeved on an outer periphery of a side of the fixed brake member away from the rotary outer sleeve.
